(19) United States
(12) Patent Application Publication
(10) Pub. No.: US 2024/0054428 A1
(43) Pub. Date: Feb. 15, 2024

(54) KEY PERFORMANCE INDICATORS COMPUTING PLAN GENERATION

(71) Applicant: ALTICE LABS, S.A., Aveiro (PT)

(72) Inventors: Manuel Jorge ESTEVÅO DE ARAÙJO, Aveiro (PT); Miguel Rui PEREIRA MARQUES, Aveiro (PT); Paulo Miguel BREDA VIEIRA, Aveiro (PT)

(21) Appl. No.: 18/269,425

(22) PCT Filed: Dec. 14, 2021
(86) PCT No.: PCT/IB2021/061715

§ 371 Date: Jun. 23, 2023

(30) Foreign Application Priority Data
Dec. 23, 2020 (PT) 116969

(51) Int. Cl. G06Q 10/0639

(52) U.S. Cl. CPC G06Q 10/06393

(57) ABSTRACT

A unit may use metadata associated with a key performance indicator (KPI) to generate a set of instructions for another unit on how it can load and process the data needed to calculate the value of that KPI, as well as how to calculate the KPI itself and how and where to persist the results. Using information about that set, the unit can generate a different set of instructions to detect any data-syncing issues that may have affected previously obtained KPI values. For that purpose, the unit comprises a plan execution module and a plan generator module adapted to generate plans for calculating KPIs. A plan comprises instructions to: i.) access to a processing system's raw data on data sources, ii.) process said information, iii.) and send the output to data sinks.

### FIELD OF THE INVENTION

This invention relates to computer systems and to the calculation of key performance indicators.

### PRIOR ART

Computer systems can be used to assess the performance, health and other operational parameters of systems that produce statistics related to their current or past state, such as electronic devices (e.g. manufacturing or networking devices), other computer systems or companies. Users may build key performance indicators (KPIs) using this data to evaluate the operation of the aforementioned systems, based on a set of criteria defined within an organization. KPIs can be created by a user and be displayed on graphics, charts and other reporting artefacts. They can be used to present the status of a system, measure its progress towards a business goal and detect operational problems. The KPIs, data sources and managed systems' metadata are usually persisted in one or more databases.

The calculation of these KPIs usually involves loading data from a database or other information storage systems, aggregating said data on spatial and/or temporal dimensions and applying user-defined or predetermined mathematical or logical expressions to the output of these operations. This whole process can either be triggered periodically or through the action of a user on the interface of a computer system in ad-hoc fashion. The resulting values may then be stored in databases for further analysis and for keeping historical data, or consumed directly by a user on an interface.

### Problem to be Solved

The calculation of multiple key performance indicators (KPI) over millions of data points can be a complex endeavor and typically involves the need for powerful computational systems. If the system being evaluated needs real-time or near real-time monitoring then the time spent on all the operations involved should be as short as possible so that data is readily available for evaluation. As more KPIs are added and more systems are monitored, the computational requirements go up, as well as the complexity of the computer system being used to perform such operations: correlation between different KPIs needs to be addressed, as well as the relations between the data sources being used so that computational and networking resources are not wasted on any redundant steps. The number and complexity of the steps needed to perform these calculations also increases as the number of variables and data sources used by the KPIs grows.

On periodical calculations of KPIs, another situation arises in that sometimes the raw data might not be have been fully available at the time of execution and is at a later date, so those periods should be identified for later reprocessing.

The burden of defining the expression and generic information (e.g. name) of a KPI may be on the user, but they should not be required to define the steps involved in its calculation.

### SUMMARY OF THE INVENTION

One implementation of the invention encompasses the steps necessary to generate a plan with all the actions needed to calculate one or more key performance indicators (KPI) and persist or redirect the results to other systems, and execute said plan. Other implementation uses the invention to generate and execute a plan to find if there is new data on the data source(s) that wasn't available at the time of a previous execution of the collection plan, so that a new one may be created and executed.

According to one aspect of the invention, a system provides a set of operations to collect, process and output data. These operations may define zero, one or multiple parent operations, so that the output of the parent is the input of the child, and may have multiple configuration parameters. This system can execute a set of operations, or a plan, starting with all the operations with no parents and following through their children, waiting for all parent operations to be finished when one has multiple parents, and stopping on operations with no children; akin to traversing a tree with one or more starting points.

According to another aspect of the invention, a system is used to generate a collection plan based on information regarding one or multiple KPIs, the system they refer to (henceforth referred to as managed entity type, or MET), and the data sources that contain the raw data of said system. This information should be available on a catalog or inventory containing information such as, but not limited to: data source access information and description (e.g. data periodicity, delay between data generation and storage, raw values, attributes), mapping between data source attributes and to those pertaining to the managed entity type the user wants to monitor or evaluate, mapping between data sources for data enrichment, KPI definition (periodicity, delay, spatial/time aggregations, expression and filters), the relation between a managed entity type's KPI and the counters (raw values from the data sources) used in its expression, and data output configurations. The system analyses a KPI as it is created and determines the operations needed to collect the raw data, process it, calculate the KPI's value and store it. As more KPIs are added to the system, should they share the MET, period and delay, they will have their plans merged: this involves sharing operations when they have the same configurations and creating new ones when they don't (for example, accessing the same data source vs. accessing a data source not yet present in the plan, respectively). Expressions are converted to a format readily executable by the plan's execution system. All the information needed to execute the operations is in the plan, so that the system that will execute it has no need to access any information sources for metadata at runtime.

In yet another aspect of the invention, a system is used to generate a plan, based on the information on the data sources present in the inventory and the relation between the KPIs and the data sources, to try to find if there was new data added to the data sources on previously collected periods. This recovery detection plan makes use of the same operations provided for the collection plan and information in inventory on a sequence number for every data source of every plan for the most recent collected time period. This sequence number is used by the system to validate if there is data, related to time periods older than the most recent currently on the data sources, being inserted later than expected.

### DESCRIPTION OF FIGURES

FIG. 1 is a block diagram describing the execution of a plan, according to one aspect of the invention.

FIG. 2 is a block diagram describing a plan, according to one aspect of the invention.

FIG. 3 is a block diagram describing the generation of a plan, according to one aspect of the invention.

FIG. 4 is an entity-relation diagram describing the inventory, according to one aspect of the invention. The reference signs represent:
4.1—Data Repository: Name, Location, Access credentials;
4.2—MET: Name;
4.3—Plan: Name, Period, Delay, Generated Plan;
4.4—Data Source: Name, Period, Delay;
4.5—KPI: Name, Type, Period, Delay, Expression;
4.6—Filter: Name, Expression;
4.7—Attribute;
4.8—Counter;
4.9—Sequence: Sequence number, Date.

FIG. 5 is a class diagram describing an operation and FIG. 5A-5G is a set of class diagrams describing various types of operations, according to one aspect of the invention. The reference signs represent:
5.1—Operation—operationName: String; parents: List<Operation>; children: List<Operation>.
5A.1—Load—sourceLoaderClass: String; configuration: GenericConfiguration; schema: List<ReadField>.
5B.1—Join—leftContext: List<String>; rightContext: List<String>; leftSelect: List<String>; rightSelect: List<String>; joinType: JoinType.
5C.1—Filter—expression: Expression;
5C.1.1—Expression—type: String; alias: String; parameterNamesAlias: Map<String, String>; constants: Map<String, ConstantDefinition>; temporary: false; configuration: GenericConfiguration.
5D.1—Aggregate—context: List<String>; aggregations: List<Aggregation>.
5E.1—Project—mappings: Map<String, String>.
5F.1—MultiJoin—context: List<String>.
5G.1—Calculate—context: List<String>; expression: List<Expression>;
5G.1.1—Expression—type: String; alias: String; parameterNamesAlias: Map<String, String>; constants: Map<String, ConstantDefinition>; temporary: false; configuration: GenericConfiguration.
5H.1—Sink—sinkClass: String; configuration: GenericConfiguration.

FIG. 6 is a class diagram describing a plan, according to one aspect of the invention. The reference signs represent:
6.1—ConfigurablePlan—nodes: Collection<Operation>; configuration: GenericConfiguration.
6.2—Plan—nodes: Collection<Operation>.

FIG. 7 is a block diagram describing the nodes of a KPI collection plan, according to one aspect of the invention.

FIG. 8 is a block diagram describing the nodes of a recovery detection plan, according to one aspect of the invention.

### DETAILED DESCRIPTION

The present disclosure relates to computer systems, some aspects in particular to the calculation of key performance indicators (KPIs) from a series of data events. While the present disclosure is not limited to this application, it provides a context for certain aspects of the invention.

In the present disclosure, timestamped data generated by or collected from physical or logical systems is said to be stored in data sources: databases, filesystems or other computer readable storage mediums. In embodiments, the metadata of such data sources is divided in attributes (data used to identify or describe aspects of the system), counters (raw data values) and descriptors such as, but not limited to, name, periodicity of the stored data. For example, a database containing data related to network routers interfaces might have as attributes the name of the interfaces, their bandwidth and the name of the router; counters could be the number of incoming and outgoing packets, packets with errors, etc.; and the descriptors would be the name of the table where the data is located, periodicity of data collection from the router, access credentials to the database and other pertinent information.

Data sources can be used as repositories of data records of one or more systems, as described above, but can also be used as repositories of enrichment data. This data can be used to provide additional information about entities contained in other data sources. A database table containing performance data about a given equipment, for example, may not have other, more generic information about the equipment such as the equipment's manufacturer or its physical location. Data enrichment can fill this gap and enhance the information given by data sources containing performance data, as long as the system can determine how to link this information.

In the present disclosure, a managed entity type (MET) is a description of a system, device, process or organization whose performance over time may be evaluated. It is defined by its name and a set of attributes describing the system it is meant to portray and can be related to other METs in hierarchical fashion, meaning METs may share a subset of attributes. The attributes of a MET are mapped to those defined in one or more data source's metadata—that is, attribute A of a data source corresponds to attribute X of a MET—linking in this way the raw data of a system to its abstraction as a managed entity type. A managed entity type can be represented on a database by one or more tables, so by collecting and processing the raw data and placing the result in the corresponding tables, a user can then use that data to monitor the progress of every instance, or entity, of the MET. This can be done by defining KPIs, which are a measure of progress of a certain aspect of a system, based on a set of criteria defined within an organization.

In embodiments, a KPI of a managed entity type may be defined by a user as a mathematical or logical expression applied periodically to aggregated raw data, built upon the counters and/or attributes of the data source, or other KPIs of those or other related METs. This means that a KPI may contain in its expression both attributes and counters from a data source and also attributes and KPIs from a MET, and have mathematical or logical operations applied to them. From a data analysis standpoint it is useful for KPIs to be periodical, so that their evolution can be evaluated and monitored over time and compared over homologous periods. A KPI's period is at least equal to that of the counters of the data sources it is related to. If the period is greater, this means that a time aggregation must be applied to the data from those data sources, so that the results are in the time frame of the KPI. Also, if attributes of the MET the KPI belongs to are less than the attributes of the underlying data source, the data must be aggregated spatially so that the non-mapped attributes are eliminated from the result.

In embodiments, a user can define functions, equal in every respect to the definition of a KPI but for the fact that they can only be used as arguments of a KPI and their value is not calculated otherwise. Functions are useful as way of reusing the same operation over different KPIs. For example, if the operation A+B*C is reused over multiple KPIs of a given MET, then a user can create a single function with that expression and simply use the function as an argument of the formula of those KPIs; also, since the formula of the KPI contains only a reference to the function and not its expression, a change or correction to the formula is done in a single place.

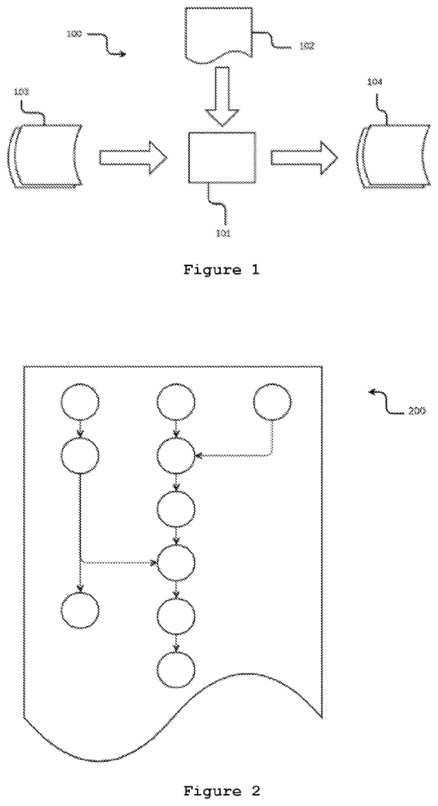

FIG. 1 is a block diagram describing a KPI unit calculator (100) used to calculate KPIs of a given system. Module (101) is a computer program that is able to execute a set of instructions delivered to it as a plan (102). Plan (102) is a file or a serialized representation of the data in a file which contains the instructions to access that system's raw data on data sources (103), process this information, and send the resulting output to data sinks (104). Data source (103) can be one or more databases, filesystems or other computer readable storage mediums where data pertaining to one or more systems is stored. Data sink (104) can be one or more databases, filesystems, other computer readable storage mediums, or other applications or computer systems such as, but not limited to, messaging systems. Plan (102) is illustrated in FIG. 2, as a graph (200) which describes the steps needed to execute the plan: execution starts at the nodes with no connections to them (inputting data from data sources (103) as per the previous example) and finishes at the ones with no connections from them (outputting data to data sinks (104) as per the previous example). In embodiments, a plan's steps, or operations, can be executed in parallel by module (101) but a given operation can only start executing when all of its input (or parent) operations have finished executing. The information contained in a plan should be sufficient for module (101) to execute its instructions without having to access external systems for metadata or other information about its components.

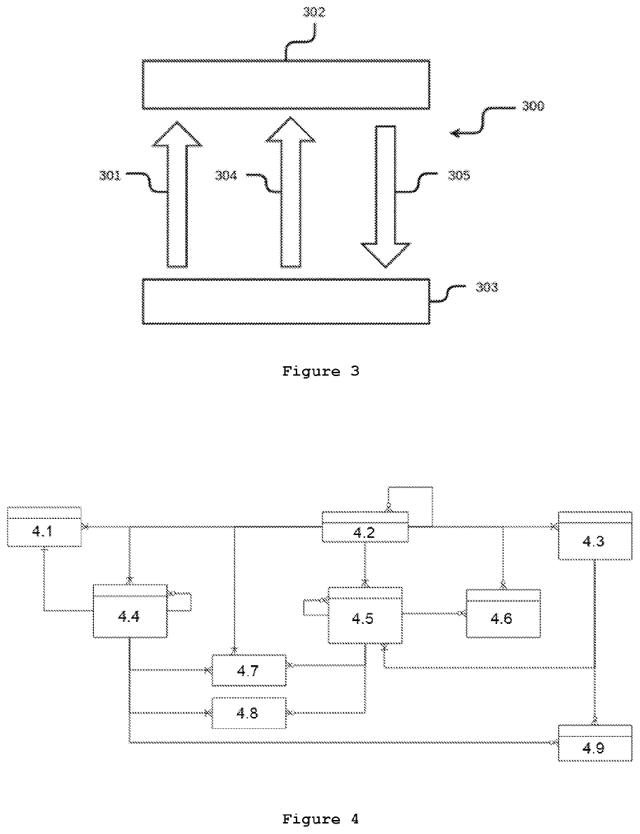

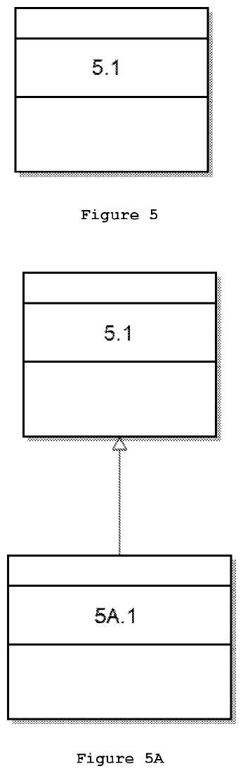

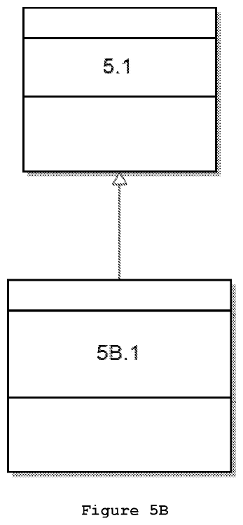

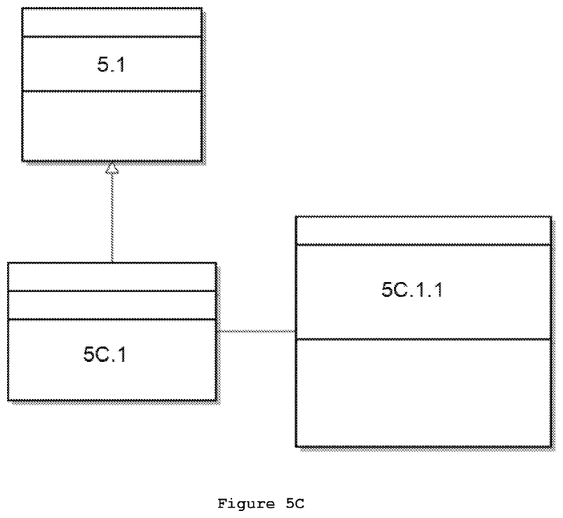

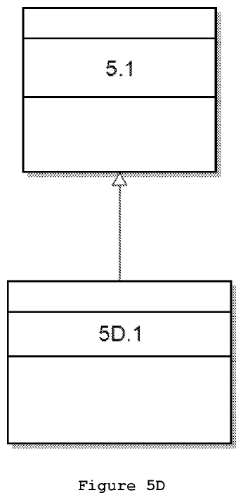

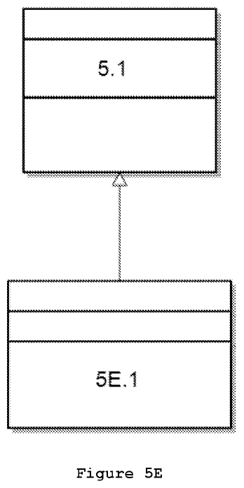

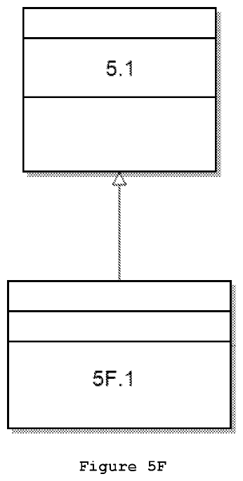

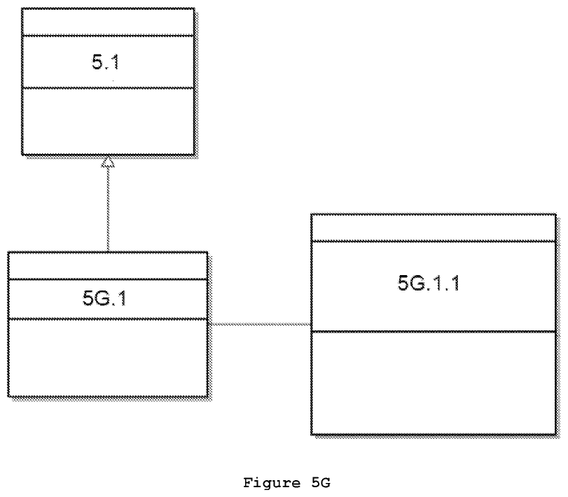

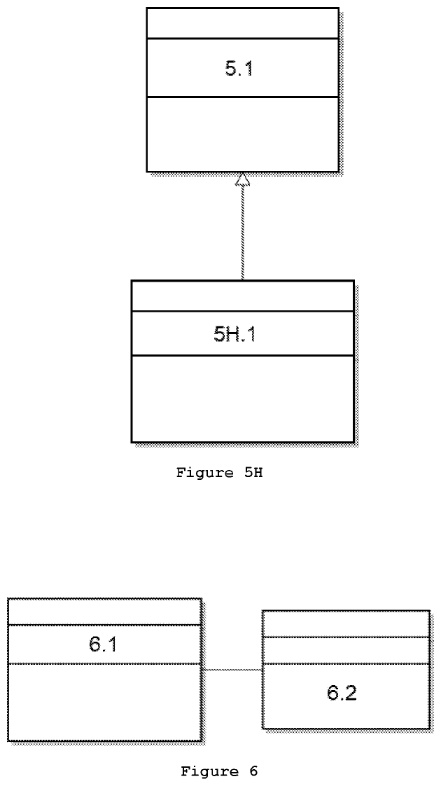

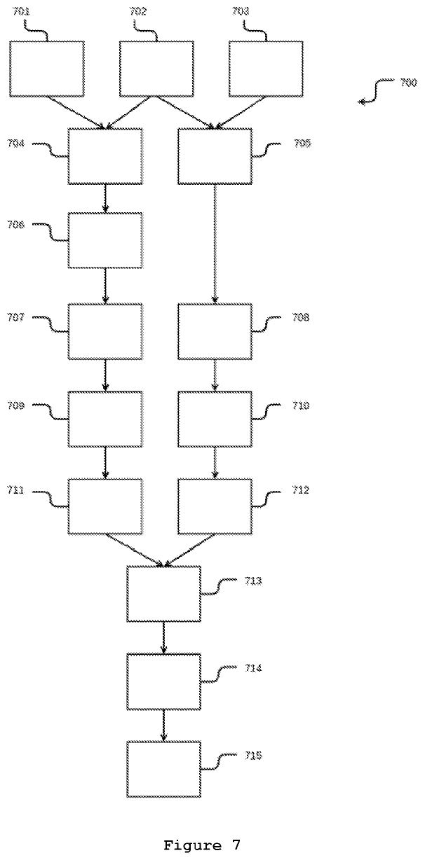

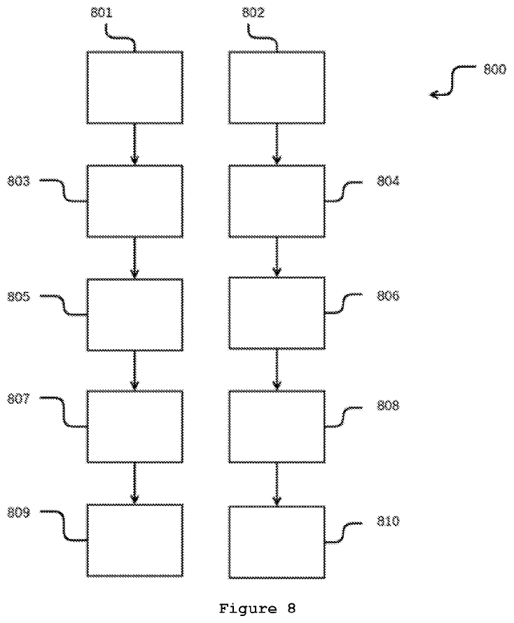

Plans are generated from metadata of KPIs, the systems (managed entity types) they are meant to supply information about, the sources of that information and the destination of their output. This is illustrated in FIG. 3, in module (300). When a new KPI definition (301) is created in inventory module (303), that information is sent to module (302), which is then responsible for generating plan (305) based on KPI definition (301) and metadata (304). Module (302) is a computer program, described herein, capable of generating sets of instructions based on the definition of a KPI and information contained on one or more inventory systems. KPI definition (301) is comprised of attributes including, but not limited to, the KPI's name, the name of the managed entity type (MET) it refers to, periodicity, delay (time difference between the expected availability of raw data and the time period it refers to), its formula or expression, aggregations and any associated filters. For the rest of the information, plan generator (302) accesses inventory (303), from where it extracts metadata (304) for all the objects deemed pertinent and the relations between them. Inventory (303) is also responsible for storing the plans generated by module (302).

Inventory (303) is a module whose content can be organized logically as described in FIG. 4. Although FIG. 4 illustrates an Entity-Relationship model, this information does not have to be on the same physical database, as long as the relations between the entities can be resolved externally by using one or more fields. A MET is identified in this inventory by its name and can have one or more attributes, one or more KPIs, filters, relations to other METs, one or more associated plans, a relation to one or more data sources and to data repository definitions. The latter contains information needed to configure access to both a data source (103) and a data sink (104).

A data source (103) is defined by its name, data generation periodicity and delay between data generation and storage. It can have one or more attributes and one or more counters, as well as relations to other data sources and a relation to a data repository definition. The relation between a MET and a data source (103), another MET or between data sources (103) is described by the mappings between their attributes. Data sources (103) may be related to each other to define enrichment data.

A KPI is defined by its name, type (KPI or function), periodicity, delay and expression. A KPI belongs to a MET and can be related to zero or more attributes of an MET or data source (103), zero or more counters from a data source (103) or zero or more KPIs, depending on what is defined by its expression. A KPI can also be related to zero or more filters, which in turn are defined by their name and expression. The expression of a KPI should be defined by its formula, containing references to the counters, KPI and/or attributes of a MET or data source, and also defines the space and time aggregations to be applied to each of them if needed. The delay of a KPI should be equal to the highest delay of all of the data sources it references. Similarly, its period cannot be inferior to the highest period of all of the data sources it references.

A plan (102) in inventory (303) is defined by its name, period, delay and the plan generated by module (302). A plan belongs to a MET and is related to one or more KPIs with the same period and delay.

Plans (102) and data sources (103) are related with each other by zero or more sequences. A sequence object is defined by this relation, a sequence number and a date, as it maps these attributes to a given plan and a data source (103) that was accessed by that plan (102).

Being the plan execution module (101) that executes a plan (102), it defines a plan's steps, or operations, as the actions that it is capable of executing. As illustrated in the class diagram in FIG. 5, an operation is defined by its name, its parent operations and its child operations. Every operation defined in module (101) is an extension of the operation in FIG. 5, inheriting in this way the aforementioned attributes. In embodiments, an operation can compute its output as a list of rows from a table, where each entry has a name, type and value associated. An operation output is used as input of the operation's children, but it is not obligatory for an operation to have parents or children.

FIG. 5A illustrates the Load operation, which retrieves data from a data source. In embodiments, this operation has no input operations and adds three attributes to the ones defined by its parent class: source loader class, configuration and schema. Source loader class is the name of the class that actually implements this operation in embodiments. Data sources can be a number of different systems and each has a different way to access their data; filesystems and databases, for example, are accessed in very different ways. Some database systems implement SQL distinctly or don't use SQL at all, so different data sources may need distinct classes to implement this operation. In addition to the class used to implement the access, the configuration attribute should contain the information needed to execute the Load operation such as, but not limited to, instructions on how to retrieve the data (file paths in case of filesystems, queries and their parameters in case of databases) or time filters. Every configuration is, of course, tightly linked to the needs of the source loader class and needs to be generated accordingly. The final attribute of the Load operation, schema, is a list of fields the data source defines and the operation should be able to retrieve, identified by their name, type (text, numeric, date or null) and, optionally, a constant value.

FIG. 5B illustrates the Join operation, which is responsible for joining and/or selecting data from parent operations into a single output, akin to the “JOIN” clause in SQL. In embodiments, this operation has two input operations and adds attributes to the ones defined by its parent class: two operations, their context, their selected fields and what type of join to use. The two operations, named “left” and “right” after this operation's counterpart in SQL, are the Join operation's parents. Each operation has an associated left and right context, a list of the names of the fields that should be used to match the data of both operations. Both contexts should have the same number of entries, so that the first entry of the left context matches with the first entry of the right context, the second of the left with the second of the right, and so on. Each operation also has an associated “left” or “right” selection, containing the list of fields to select from either operation. In embodiments, the join type can be either inner, right or left, again akin to the basic types of the JOIN clause in SQL, and is used while instantiating the operation to choose the operation from where fields with matching names should come.

FIG. 5C illustrates the Filter operation, which is responsible for filtering data from a parent operation. In embodiments, this operation has a single input operation and one attribute to add to those defined by its parent class: an expression to match against the data outputted by its parent operation. The Filter operation works by executing the related expression (which should invariably return a boolean value) with the data from the parent operation and output only those whose result is true.

In embodiments, expressions are defined by their type, alias, parameter name to alias relation, constants, temporary flag and configuration. Similarly, to data sources (103) in the Load operation, expressions are implemented by different classes, in this case depending of the desired output, and have an attached configuration whose content varies according to the implementing class, but should at least contain the formula (an expression executable by module (101)) and its return type (such as, but not limited to, text, number, boolean or date). The “type” attribute identifies this class in module (101). Expressions are also identified by their alias (which is the name given to the result in the output), a temporary flag (which if true indicates the value of this expression should not be part of the output of the operation and exists only to be used as a parameter of other expression), a map to relate the name of the formula's parameters and their names on input, should they differ, and a map relating parameters of the expression to a constant value.

FIG. 5D illustrates the Aggregate operation, which is responsible for aggregating data of a parent operation. In embodiments, this operation has a single input operation and two attributes to add to those defined by its parent class: a list of fields of the parent operation to group its data by—akin to the “GROUP BY” clause in SQL- and a list of which aggregations and to which fields to apply them.

FIG. 5E illustrates the Project operation, which is responsible for mapping names of fields from a parent operation. In embodiments, this operation has a single input operation and an attribute to add to those defined by its parent class: a map of aliases for the fields. It supports one to many mapping, so one field can be mapped to multiple aliases. It can also eliminate fields from its input if they are not contained in this map.

FIG. 5F illustrates the Multi-Join operation, which is responsible for joining the input of multiple operations into a single output. In embodiments, this operation has multiple input operations and one attribute to add to those defined by its parent class: a list of names of fields called context. This context is used for the operation to know which fields to use when matching the data from the parent operations.

FIG. 5G illustrates the Calculate operation, which is responsible for calculating the value of an expression using data from an input operation and associating that value to an entity. In embodiments, this operation has single input operation and adds two attributes to those defined by its parent class: a list of names of fields from the parent operation and a list of expressions. The list of names of fields provides the context from which to identify the entities the resulting values belong to and the list of expressions contains one or more expressions whose formula to calculate. Unlike the Filter operation, which also uses expressions in its execution, the Calculate operation makes no assumption over the return type of its expressions.

FIG. 5H illustrates the Sink operation, which outputs data to a data sink (104). In embodiments this operation has a single input operation, no children operations and adds two attributes to the ones defined by its parent class: sink class and configuration. Sink class is the name of the class that actually implements this operation in embodiments. Data sinks can be a number of different systems and each has a different way to input data; for example, data can be saved in files in multiple formats, databases may use SQL expressions and other systems might have callable APIs, so different data sinks may need different classes to implement this communication. In addition to the class used to implement the data output, the configuration attribute should contain all the information needed to execute the Sink operation such as, but not limited to, how to output the data (e.g.: file paths in case of filesystems) or client API configurations.

FIG. 6 illustrates a Configurable Plan and a Plan. A Plan is defined by a collection of nodes, each corresponding to one of aforementioned operations, while a Configurable Plan is a wrapper providing the plan with a generic configuration object for all or some of its nodes such as, but not limited to, data source access configurations.

In embodiments, plans are generated according to their purpose: the calculation of KPIs or the detection of out-of-sync data in data sources. The latter is related to how data sources (103) have an expectation of the time the data pertaining to a given interval is stored, translated to their configured delay. For example, a data source (103) with a delay of 5 minutes is expected to have all data of a given interval stored up to 5 minutes after the end of this interval. Should that fail to happen and some or all data be stored at a later date, given the periodic nature of KPIs the unit (100) should be able to detect these situations so that a new plan can be generated for this interval for the KPIs whose data was incomplete. It should be noted, however, that a plan is only limited to the scope and capabilities of its operations and can be generated for purposes other than those previously stated.

Graph (700) in FIG. 7 illustrates the connections between the operations of what could be a plan to calculate one or more KPIs. In embodiments, the generation of such a plan starts with the definition of a KPI, as per module (300) of FIG. 3. Considering a KPI expressed by the formula A$x+B$y, where “A” and “B” are data sources, “x” and “y” are counters and “$” is a separator character denoting “x” belongs to “A” and “y” belongs to “B”, a plan like the one depicted by graph (700) could be generated by module (302) as its definition is read from inventory (303). Load operations (701), (702) and (703) are derived from the KPI's formula and its relation in inventory (303) to the data sources (103), as well as the relations between the data sources themselves. Since both the KPI and data source (103) are related to a MET, in addition to the counters attributes the KPI declares as part of its formula, the Load operations also include the attributes mapped to the MET in question. Considering operations (701) and (703) as the ones inputting data from data sources “A” and “B” from the previous example, Load operation (702) is not used to retrieve data needed to calculate the expression but to enrich the output of the other operations with attributes mapped to the MET but not contained in data sources A or B. Derived from this relation in inventory (303), two Join operations (704) and (705) are created to join this enrichment data from operation (702) with the data from operations (701) and (703).

In embodiments, operations should be able to read configurations from the plan. Should Load operations (701), (702) and (703) share the same data source access configurations, for example, module (302) can configure the plan (102) with that information in order to eliminate redundancy.

If a KPI has a filter related to it in inventory (303), then module (302) adds a Filter operation to the plan after the data is loaded from the data sources (103) and, optionally, enriched. In graph (700) this translates to operation (706) being added after the Join operation for Loads (701) and (702). For this example, there is the assumption that the filter related to KPI in question is only being applied to an attribute that is known from metadata (304) to come only from data source A, hence Filter operation (706) is only applied to data coming from that data source. Should it also apply to data source B, then a second Filter operation would be added between operations (705) and (708). A filter's expression is transpiled, or converted, from its declaration in the inventory (303) to an expression in a format executable by module (101). This transpilation process aims to reduce the time an expression needs to be evaluated, so it is not interpreted by the plan execution module (101), but executed. The return type of a filter's expression is always boolean.

The KPI's expression, as mentioned before in the present disclosure, defines the temporal and spatial aggregations the unit (100) should apply to its parameters in case of need. In embodiments, module (302) is responsible for determining whether there is the need to apply such aggregations depending of the period of the KPI being bigger than any of its data sources, and the number of attributes defined by the data sources being more than those needed by the MET. Should they apply, then the module generates Aggregate operations using that metadata to include after data is loaded, enriched and filtered, such as operations (707) and (708) for the time aggregation and (711) and (712) for the space aggregation. Operations (707) and (708) reduce the number of time intervals to a single one by grouping the data by all the data sources' attributes minus the date, while applying aggregations to counters “x” and “y”. After this time aggregation and before a spatial aggregation can be applied to the data, the number of attributes is reduced by Project operations (709) and (710). These map the names of data source attributes to those used by the MET, therefore eliminating those without mapping. This creates the conditions for operations (711) and (712) to aggregate the input data spatially by all of the MET's attributes.

If a data source and its implementing class, as seen in FIG. 5A, supports the actions performed by the Join, Filter, Aggregate and/or Project operations, module (302) may choose not to generate and add them to the plan, but to configure the Load operation to have the data source system itself execute them before or while loading the data. In embodiments, this means the implementing class of the Load operation for the data source in question may have the means to inform the plan generation module (302) if it can generate a query to the data source with the aforementioned actions, so it may decide on what operations to add to the plan and how to configure the Load operation.

In embodiments, a Calculate operation (714) is generated with all the expressions needed to calculate the KPI. If a KPI uses helper functions in its expression, their expression is pulled from inventory (303), marked as temporary and added to the operation. As is the case for filters, as mentioned previously in this disclosure, every expression has its formula transpiled, or converted, from its declaration in the inventory (303) to an expression executable by module (101). The expression's type is chosen according to the return type expected from the operations and aggregations applied to its parameters, and the rest of its configurations and definitions are derived from its input.

As the Calculate operation defines a single parent operation, if the plan has multiple branches derived from more than one Load operation as in graph (700), then the module (302) generates a Multi-Join operation to join their data into a single output. Operation (713) joins the output of operations (711) and (712) as the input for operation (714), since they are the last actions the system deems necessary to apply before the KPI is to be calculated. In embodiments, the inputs of the Multi Join operation should (but are not required to) share one or more fields and by this point the module (302) should have added at least one Project operation to the plan in order for the fields to have their names changed to the ones used by the MET, should any of them need that transformation.

In embodiments, the Sink operation is generated and configured by module (302) using the relation between a MET and the data repositories defined in inventory (303). Operation (715) is the last operation of the plan in graph (700) and it defines what happens to the output of all the previous operations.

After plan (305) is generated by module (302), it is saved in inventory (303). When handling the creation of a new KPI definition, module (302) needs to check inventory (303) for plans that share the characteristics of that KPI, namely its managed entity type, period and delay. If such a plan exists, then a new plan is generated with all these KPIs, plus the new one, and the old plan is replaced. The edition or removal of a KPI will also force the generation of a new plan. Since operations can handle multiple fields these actions may generate a plan with the same nodes as the previous iteration of the plan, the difference being the number of counters or attributes to load or aggregate, or the expression to apply when calculating a KPI or filtering data. A plan is removed from the inventory when it has no more KPIs associated with it.

Recovery detection plans can be generated much in the same fashion as KPI collection plans. Recovery detection works based on the assumption that the data stored in data sources is sequential, timestamped and that those attributes can be known. The generation starts by identifying the counters and data sources used by the KPIs of a collection plan, and the previous maximum stored in the inventory (303) for each data source-plan pair. Module (302) then generates a plan to get the largest sequence number of the time interval of that plan per data source, and to find dates where the sequence was larger than the previous maximum on a previous time interval. FIG. 8 describes such a plan, derived from the example given before for FIG. 7.

Graph (800) describes a plan with two Load operations (801) and (802), for data sources “A” and “B” as mentioned in the previous example. Each Load operation is configured to get the date and sequence number attributes from the underlying data sources, which should be identifiable in inventory (303). This data is then filtered by Filter operations (803) and (804) to get only the numbers and dates where the sequence is greater than the previous maximum, which is stored in inventory (303). The collected dates have part of their time truncated to zero and are converted to milliseconds by Calculate operations (805) and (806), and the new maximum sequence number is determined by Aggregate operations (807) and (808) using the value calculated by operations (805) and (806) as the context for these operations. The resulting data is then sent to Sink operations (809) and (810) so that the most recent maximum value is sent to the inventory. Dates that where already collected but were found to have a sequence number greater than the previous maximum will have a new collection plan generated, one that contains only the KPIs that use counter or attributes from those data sources.

Unlike KPI collection plans, where the result is related to the KPIs of an overarching MET, a recovery detection plan may have as many Sink operation per Load operation. Since the data needed for this plan concerns only the data sources, there is no need to generate a single result so each data source can be treated independently.

A number of computer systems have been described in this disclosure. It is in the scope and spirit of this invention that these systems may be implemented in separate components across multiple physical devices or virtual machines.

1. KPI unit calculator for calculating KPI of a processing system, comprising the following modules:
A plan execution module comprising processing means adapted to process a plan for calculating at least one KPI, wherein a plan is a collection of nodes, each node corresponding to one operation selected from a list of operations;
A plan generator module configured to generate at least one plan; wherein a plan comprises instructions to: i.) access to a processing system's raw data on data sources, ii.) process said information, iii.) and send the output to data sinks;
At least one data source;
At least one data sink.

2. KPI unit calculator according to claim 1, further comprising an inventory module programmed to generate KPI definitions and to collect metadata from the processing system; wherein,
The plan generator is configured to generate a plan based on the KPI definition and metadata extracted from the inventory module.

3. KPI unit calculator according to claim 2, wherein the inventory module further comprises memory means adapted to store plans generated by the plan module generator.

4. KPI unit calculator according to claim 3, wherein the plan generator module is configured to check inventory module for plans that share the characteristics of a KPI, prior to generating a new plan, such that
If a plan exists a new plan is generated with all its KPIs plus a new one; the old plan being replaced.

5. KPI unit calculator according to claim 4, wherein the characteristics of the KPI relates to entity type, period and delay.

6. KPI unit calculator according to claim 2, wherein the inventory module comprises processing means adapted to manage at least one managed entity type.

7. KPI unit calculator according to claim 6, wherein a MET is identified in the inventory module by a name; the MET comprising one or more attributes, one or more KPIs, filters, relations to other METs, one or more associated plans, a relation to one or more data sources and to data repository definitions to configure access to a data source and a data sink.

8. KPI unit calculator according to claim 2, wherein a KPI definition is comprised of attributes including, but not limited to, the KPIs name, the name of the managed entity type it refers to, periodicity, delay define as a time difference between the expected availability of raw data and the time period it refers to, a formula or expression, aggregations and any associated filters.

9. KPI unit calculator according to claim 2, wherein the operation associated to each node of a plan is defined by its name, its parent operations and its child operations.

10. KPI unit calculator according to claim 9 wherein the list of operations includes:
Load operations, for retrieving data from a data source;
Joint operations, for joining and/or selecting data from parent operations into a single output;
Filter operations, for filtering data from a parent operation;
Aggregate operations, for aggregating data of a parent operation;
Project operations, for mapping names of fields from a parent operation;
Multi-joint operations, for joining the input of multiple operations into a single output;
Calculation operations, for calculating the value of an expression using data from an input operation and associating that value to an entity; and
Sink operations, for outputting data to a data sink.

11. KPI unit calculator according to claim 1, wherein the plan generator module comprises processing means programmed to generate a plan by establishing relations between operations of the list of operations, which are connected in such a way to calculate one or more KPIs.

12. KPI unit calculator according to claim 11, wherein the plan generator module is configured to determine whether there is a need to apply temporal and spatial aggregations, depending of the period of the KPI being bigger than any of data sources, and the number of attributes defined by the data sources being more than those needed by a MET.

13. KPI unit calculator according to claim 10, wherein in case temporal and spatial aggregations are to be applied, the plan generator module generates aggregate operations.

14. KPI unit calculator according to claim 1 wherein a data source is one or more databases, filesystems or other computer readable storage mediums where data pertaining to one or more processing systems is stored.

15. KPI unit calculator according to claim 2, wherein the data sink is one or more databases, filesystems, other computer readable storage mediums, or other applications or computer systems such as, but not limited to, messaging systems.
